(19) United States
(12) Patent Application Publication
(10) Pub. No.: US 2021/0251229 A1
(43) Pub. Date: Aug. 19, 2021

(54) PLANT REGULATOR COMPOSITIONS

(71) Applicant: Suntton Company Limited, Hong Kong (CN)

(72) Inventors: Xi Wang, Chilliwack (CA); Liping Peng, Sacramento, CA (US)

(73) Assignee: Suntton Company Limited

(21) Appl. No.: 17/158,965

(22) Filed: Jan. 26, 2021

Related U.S. Application Data
(60) Provisional application No. 62/976,946, filed on Feb. 14, 2020.

(51) Int. Cl. A01N 43/22; A01N 25/12; A01N 25/04; A01N 43/16; A01N 57/20; A01N 25/26

(52) U.S. Cl. CPC A01N 43/22; A01N 25/12; A01N 25/26; A01N 43/16; A01N 57/20; A01N 25/04

(57) ABSTRACT

This disclosure includes plant regulator compositions, which contain at least one active component selected from a group consisting of bras sinosteroids family and one or more components selected from a group consisting of other plant regulators that are not part of the bras sinosteroids family. The disclosure provides plant regulator compositions, which perform in a more balanced way in the field of agriculture. When being used with the other plant regulators, brassinosteroids play a role in correcting excessive unidirectional growth caused by other plant regulators.

### CROSS-REFERENCE TO RELATED APPLICATION(S)

This application claims priority under 35 U.S.C. § 119(e) of the U.S. Provisional Patent Application Ser. No. 62/976,946, filed Feb. 14, 2020 and titled, “Plant Regulator Compositions,” which is also hereby incorporated by reference in its entirety for all purposes.

### FIELD OF THE INVENTION

The present invention relates to plant regulator compositions. More specifically, the present invention relates to plant specific steroidal hormones.

### BACKGROUND OF THE INVENTION

Typical plant regulator compositions have their limitations in promoting the growth of the plants.

### SUMMARY OF THE INVENTION

Brassinosteroids (BRs) are plant specific steroidal hormones, characterized by their polyhydroxylated sterol structure and were first isolated from Brassica napus pollen. BRs are regarded as a class of essential plant hormones that plays diverse roles in plant growth and developmental processes, including cell elongation, cell division, root growth, photomorphogenesis, stomatal and vascular differentiation, seed germination, immunity and reproduction. BRs are also involved in regulating the metabolism of plant oxidation radicals, ethylene synthesis and root gravitropic response, and have a role in mediating plant responses to stress, such as freezing, drought, salinity, disease, heat and nutrient deficiency. Also, BRs interact with different plant regulators such as auxin, cytokinin, ethylene, gibberellin, jasmonic acid, abscisic acid, polyamine etc. in regulating wide range of physiological and development processes in plants. With these function networks, in multiple component compositions in accordance with some embodiments, BRs work with other plant regulators in a synergistic way to enhance their functions essential to plants and counterbalance those side effects caused by individual active components.

### BRIEF DESCRIPTION OF THE DRAWINGS

Embodiments will now be described by way of examples, with reference to the accompanying drawings which are meant to be exemplary and not limiting. For all figures mentioned herein, like numbered elements refer to like elements throughout.

FIG. 1 illustrates a chart for forming a plant regulator composition in accordance with some embodiments.

FIG. 2 illustrates a plant regulator composition application method in accordance with some embodiments.

### DETAILED DESCRIPTION OF THE PREFERRED EMBODIMENT

Reference is made in detail to the embodiments of the present invention, examples of which are illustrated in the accompanying drawings. While the invention is described in conjunction with the embodiments below, it is understood that they are not intended to limit the invention to these embodiments and examples. On the contrary, the invention is intended to cover alternatives, modifications and equivalents, which can be included within the spirit and scope of the invention as defined by the appended claims. Furthermore, in the following detailed description of the present invention, numerous specific details are set forth in order to more fully illustrate the present invention. However, it is apparent to one of ordinary skill in the prior art having the benefit of this disclosure that the present invention can be practiced without these specific details. In other instances, well-known methods and procedures, components and processes have not been described in detail so as not to unnecessarily obscure aspects of the present invention. It is, of course, appreciated that in the development of any such actual implementation, numerous implementation-specific decisions must be made in order to achieve the developer's specific goals, such as compliance with application and business related constraints, and that these specific goals vary from one implementation to another and from one developer to another. Moreover, it is appreciated that such a development effort can be complex and time-consuming, but is nevertheless a routine undertaking of engineering for those of ordinary skill in the art having the benefit of this disclosure.

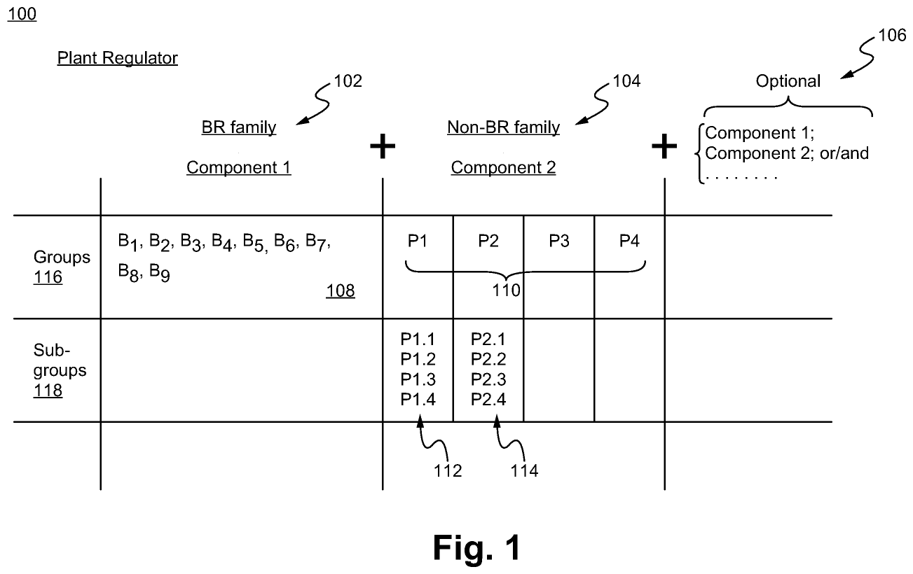

FIG. 1 illustrates a chart for forming a plant regulator composition 100 in accordance with some embodiments. In an aspect, the plant regulator composition 100 in accordance with some embodiments comprises one or more compositions from Component 1 102 and one or more compositions from Component 2 104. The Component 1 (BR family) 102 is able to be selected from one of the Groups 116, which includes group members 108 having B1, B2, B3, B4, B5, B6, B7, B8, and B9. The Component 2 Non-BR family 104, is able to be selected from the groups 110 including P1, P2, P3, and P4. P1 is able to be selected from the subgroup 112 having P1.1, P1.2, P1.3, and P1.4. P2 is able to be selected from the subgroup 114 having P2.1, P2.2, P2.3, and P2.4. More details of the compositions are described below.

The Components 1 and 2 include:

1) Component 1: one or more compounds selected from a group consisting of a compound from Brassinosteroids (BRs) family Group B1-B9:

Group B1: the main carbon skeleton of structures has norbrassinolide-like side chain, including:

28-Norbrassinolide, 28-Norcastasterone, 6-Deoxo-28-norcastasterone, 28-Nortyphasterol, 6-Deoxo-28-nortyphasterol, 28-Norteasterone, 6-Deoxo-28-norteasterone, 3-Dehydro-6-deoxo-28-norteasterone, and 26-Norcastasterone.

Group B2: the main carbon skeleton of structures has brassinolide-like side chain, including:

Brassinolide, Castasterone, 6-Deoxocastasterone, Typhasterol, Teasterone, 2-Epicastasterone, 3-Epicastasterone, 2,3-Diepicastasterone, 1β-Hydroxycastasterone, 1α-Hydroxy-3-epicastasterone, 3-Epi-6-deoxocastasterone, Teasterone-3-myristate, 3-Dehydroteasterone, Secasterone, 6-Deoxotyphasterol, 3-Dehydro-6-deoxoteasterone, 2-Deoxybras sinolide, Teasterone-3-laurate, 6-Deoxoteasterone, 6α-Hydroxycastasterone, 3-O-β-D-Glucopyranosylteasterone, 3-Epibrassinolide, 2,3-Diepisecasterone, Secasterol, Cryptolide, 23-Dehydro-2-epicastasterone, 3-Epi-2-deoxybrassinolide, and Castasterone 23-phosphate.

Group B3: the main carbon skeleton of structures has 24-epibrassinolide-like side chain, including:

24-Epicastasterone, 3,24-Diepicastasterone, 24-Epibrassinolide, 6-Deoxo-24-epicastasterone, and 24-Episecasterone.

Group B4: the main carbon skeleton of structures has dolicholide-like side chain, including:

Dolicholide, Dolichosterone, 6-Deoxodolichosterone.

Group B5: the main carbon skeleton of structures has 28-homobrassinolide-like side chain, including:

28-Homocastasterone, 28-Homobrassinolide, 28-Homoteasterone, 28-Homotyphasterol, and 6-Deoxe-28-homotyphasterol.

Group B6: the main carbon skeleton of structure has 25-homebrassinolide-like chain, including:

25-Methylcastasterone.

Group B7: the main carbon skeleton of structure has 28-homodolicholide-like side chain, including:

28-Homodolicholide, 28-Homodolichosterone, and 6-Deoxo-28-homodolichosterone.

Group B8: the main carbon skeleton of structure has 25-homodolicholide-like side chain, including:

25-Methyldolichosterone, 2-Deoxy-25-methyldolichosterone, 3-Epi-2-deoxy-25-methyldolichosterone, 2-Epi-25-methyldolichosterone, 2,3-Diepi-25-methyldolichosterone, 6-Deoxo-25-methyldolichosterone, 23-O-β-D-Glucopyranosyl-25-methyldolichosterone, and 23-O-β-D-Glucopyranosyl-2-epi-25-methyldolichosterone.

Group B9: miscellaneous, including:

Cathasterone, 28-Epihomobrassinolide, 22,23,24-Triepibrassinolide, 14-hydroxylated brassinosteroid, 22,23-Epoxybrassinosteroid-2,3-diacetates, and Biobras-16.

2) Component 2: one or more plant regulator selected from Group P1 to P4.

Group P1) Plant growth promoters and stimulators:

P1.1 Auxins and Auxin-like compounds: Indole-3-acetic acid (IAA) and its salts, Indole-3-butyric acid (IBA) and its salts, Naphthalene-acetic acid (NAA) and its salts, 1-Naphthaleneacetamide(NDA), 2,4-Dichlorophenoxyacetic acid (2,4-D) and its salts or esters, 2-(2,4-dichlorophenoxy) propanoic acid (2,4-DP) and its salts or esters, 4-Chlorophenoxyacetic acid (4-CPA) and its salts or esters, and Ethychlozate.

P1.2 Cytokinins: 6-Benzyladenine (6-BA), Kinetin, Forchlorfenuron (CPPU), Zeatin, trans-Zeatin, Isopentenyladenine (2iP), and Thidiazuron (TDZ).

P1.3 Gibberellic acid A3 (GA3) and Gibberellins A4/A7 (GA4, GA7, GA4+7).

P1.4 Unclassified plant growth promoters and stimulators: Triacontanol, Diethyl aminoethyl hexanoate citrate (DA6), Sodium ortho-nitrophenolate, Sodium para-nitrophenolate, Sodium 5-nitroguaiacolate, or a combination thereof.

Group P2) Plant growth retardants and inhibitors:

P2.1 Abscisic Acid (ABA and S-ABA).

P2.2 Anti-auxins: Maleic hydrazide and its salts, and Mefluidide.

P2.3 Anti-gibberellins: Chlormequat chloride (CCC), Mepiquat chloride, Mepiquat pentaborate, Paclobutrazol, Uniconazole, Daminozide, Trinexapac-ethyl, Prohexadione calcium, Flurprimidol, and Ancymidol.

P2.4 Unclassified plant growth retardants and inhibitors: Butralin, Cyclanilide, Chlorpropham (CIPC), and Choline chloride.

Group P3) Ethylene releasers: 2-chloroethylphosphonic acid (Ethephon)

Group P4) Miscellaneous plant regulators and biostimulators:

Allantoin, Gamma-Aminobutyric Acid (GABA), Complex Polymeric Polyhydroxy Acids (including Humic acid, fulvic acid, tannins, and organic acids from Leonardite) (CPPA), L-Glutamic Acid, Harpin proteins, Jasmonates (includes all derivatives of jasmonic acid), Seaweed Extracts, Chitosan, Oligosaccharides (includes all derivatives), Polyamines (PAs), Lysophosphatidylethanolamine (LPE), Laminarin, Potassium silicate, 1-Octanol, Vitamin C (Vc), Salicylic acid (SA), Strigolactones or a combination thereof.

In an aspect, the plant regulator compositions in accordance with some embodiments comprises at least one composition of Component 1 and at least one composition of the Component 2, wherein the Component 2 comprises at least one composition from Group P1, P2, P3, or P4.

In another aspect, the plant regulator compositions in accordance with some embodiments comprise a Component 1, a Component 2, and a Component 3, wherein the Component 3 comprises an active compound. The Component 3 is selected from Brassinosteroids and/or other plant regulators (Group P1, P2, P3 and P4) disclosed herein. In some embodiments, Component 3 is one or more of the compounds selected from one of the same groups/sub-groups of Component 1 and/or Component 2. In other embodiments, Component 3 are one or more of the compounds selected from one of the different groups/sub-groups of Component 1 and/or Component 2.

In another aspect, the plant regulator compositions in accordance with some embodiments comprise Components 1, 2, 3, 4, 5 and 6, wherein the Components 4, 5, and 6 are selected from Brassinosteroids and other plant regulators (groups P1, P2, P3 and P4) disclosed herein. In some embodiments, Components 3, 4 and 5 are compounds selected from the same groups/sub-groups of Component 1 and/or Component 2. In other embodiments, Components 3, 4, and 5 are the compounds selected from the different groups/sub-groups of Component 1 and/or Component 2. A person of ordinary skill in the art appreciates that any additional compounds and/or any numbers of the above-mentioned Components are able to be added to the combination of Components 1 and 2.

In some embodiments, the weight ratio of a two-component composition (e.g., plant regulator) of the Component 1 and Component 2 is in the range of from 1:40,000 to 40,000:1. In some embodiments, the weight ratio of the Component 1 and Component 2 is in the range from 1:1,000 to 100:1. In some embodiments, the weight ratio of the Component 1 and Component 2 is in the range from 1:40 to 40:1.

In some embodiments, the weight ratio of a three-component composition of Component 1: Component 2 and Component 1: Component 3 are in the range of from 1:40,000 to 40,000:1. In some embodiments, the weight ratio of Component 1: Component 2 and Component 1: Component 3 is 1:1,000 to 100:1. In some embodiments, the weight ratio of Component 1: Component 2 and Component 1: Component 3 is in the range from 1:40 to 40:1. In some embodiments, the ratio of Component 1: Component 3 is in the range of from 1:1000 to 1000:1. In some embodiments, the ratio of Component 1: Component 3 is in the range of from 1:40 to 40:1.

In some embodiments, the weight ratio of a multiple component compositions, such as a four-component composition, the further active component is added in a ratio of from 1000:1 to 1:1000 to the Component 1.

In some embodiments, the compositions are prepared in common types of agrochemical formulations, such as solutions, emulsions, suspensions, dusts, powders, pastes, granules, pressings and capsules. The types of formulations can be defined in the “Catalogue of pesticide formulation types and international coding system”, Technical Monograph No. 2, 7^{th} Edition, Revised March 2017, CropLife International. The compositions are prepared in a typical known chemical formulation preparation manner, such as described in the “Formulation technology” by Mollet and Grubemann, WILEY-VCH, 1^{st} Edition, 2001.

In some embodiments, the compositions contain auxiliaries, such as solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers and binders.

In some embodiments, solvents and liquid carriers used include water; alcohols such as ethanol; glycols such as propylene glycol; DMSO; ketones; esters such as fatty acid esters; crop oils; aliphatic, cyclic and aromatic hydrocarbons such as toluene, paraffin, tetrahydronaphthalene; fatty acids; phosphonates; amines; amides and the like. Water is generally the carrier of choice for the dilution of concentrates.

In some embodiments, solid carriers or fillers used are talc, titanium dioxide, pyrophyllite clay, silica, attapulgite clay, kieselguhr, chalk, diatomaxeous earth, lime, calcium carbonate, bentonite clay, fuller's earth, fertilizer, cotton seed hulls, wheat flour, soy bean flour, pumice, wood flour, walnut shell flour, lignin and the like.

In some embodiments, surfactants used are surface-active agents, such as anionic, cationic, non-ionic and amphoteric surfactants, block polymers, polyelectrolytes and the like. These surfactants are able to be used as emulsifier, dispersant, solubilizer, wetter, penetration enhancer, protective colloid, or adjuvant.

Surfactants include salts of alkyl sulfates, alkylarylsulfonate salts, alkylphenol-alkylene oxide addition products, alcohol-alkylene oxide addition products, soaps, alkyl naphthalene sulfonate salts, quaternary amines, polyethylene glycol esters, dialkyl ester of sulfosuccinate salts, polyethylene glycol esteros of fatty acids, and salts of mono and dialkyl phosphate esters are within the scope of the present disclosure.

In some embodiments, thickeners used include polysaccharides, anorganic clays, polycarboxylates, and silicates.

In some embodiments, anti-freezing agents used include ethylene glycol, propylene glycol, urea and glycerin.

In some embodiments, anti-foaming agents used are silicones, long chain alcohols, and salts of fatty acids.

In some embodiments, colorants used are pigments of low water solubility and water-soluble dyes.

In some embodiments, tackifiers or binders used are polyvinylpyrrolidons, polyvinylacetates, polyvinyl alcohols, polyacrylates, biological or synthetic waxes, and cellulose ethers.

The examples below are exemplary compositions and their preparation.

1) Water-Soluble Concentrates

0.01-60% (w/w) active ingredients (e.g., Compositions 1 and 2) are dissolved in water and/or in a water-soluble organic solvent (e.g., ethanol 5-10% (w/w)) wetting agents (e.g., polyoxyethylene esters) are added to the solution and mix well.

2) Dispersible Concentrates

0.01-30% (w/w) active ingredients are dissolved in organic solvent (e.g., propylene glycol 1-10% (w/w)), dispersants (e.g., polyalkylene oxide derivatives of alcohols) are added to the solution and mix well.

3) Emulsifiable Concentrates

1-65% (w/w) active ingredients and 2-10% (w/w) emulsifiers (e.g., ethoxylated octylphenol) are dissolved in water-insoluble organic solvent (e.g., xylene) and mix well.

4) Emulsions

1-65% (w/w) active ingredients and 2-10 wt % emulsifiers (e.g., ethoxylated octylphenol) are dissolved in water-insoluble organic solvent (e.g., xylene). The solution is diluted with water and mix well.

5) Suspensions

1-50% (w/w) active ingredients, 2-8% (w/w) wetting agents (e.g., polyoxyethylene esters), 2-8% (w/w) dispersants (e.g., polyalkylene oxide derivatives of alcohols), 0.2-2% (w/w) thickeners (e.g., Hypromellose) and water are ground finely, then make the after grinding treatments as needed and give suspensions.

6) Water-Dispersible Granules and Water-Soluble Granules

1-80% (w/w) active ingredients, wetting agents (e.g., polyoxyethylene esters) and dispersants (e.g., polyalkylene oxide derivatives of alcohols) are ground finely. Make granules in known manners such as fluidized bed.

7) Water-Dispersible Powders and Water-Soluble Powders

1-80% (w/w) active ingredients, 1-5% (w/w) wetting agents (e.g., polyoxyethylene esters), 1-5% (w/w) dispersants (e.g., polyalkylene oxide derivatives of alcohols) and solid carriers are ground finely.

8) Dustable Powders

0.01-10% (w/w) active ingredients and solid carrier are ground finely.

9) Granules

0.01-25% (w/w) active ingredients and solid carriers are ground finely. Make granules in known manners (e.g., fluidized bed).

Crops in which the compositions are able to be used include, but not limited to, various vegetables (e.g., potato, sugar beet, onion, lettuce, broccoli, cabbage, bean, lentil, pea, soybean, cucumber, squash, watermelon, cantaloupe), citrus fruits (e.g., lemon, mandarin, orange), pome fruits (e.g., apple, pear), stone fruits (e.g., apricot, cherry, peach, plum), berries and small fruits (e.g., blueberry, raspberry, blackberry, grape, kiwifruit, strawberry), tree nuts (e.g., almond, pecan, walnut), cereal grains (e.g., wheat, barley, corn, oats, rice, rye), cotton and oil crops (e.g., rape, sunflower).

The appropriate application method and timing depend on the effect desired, which should be in accordance with standards known in the field. Effective methods include seed treatment, spraying on the plants surface, dripping irrigation, drench application, in-furrow application, injection into plants.

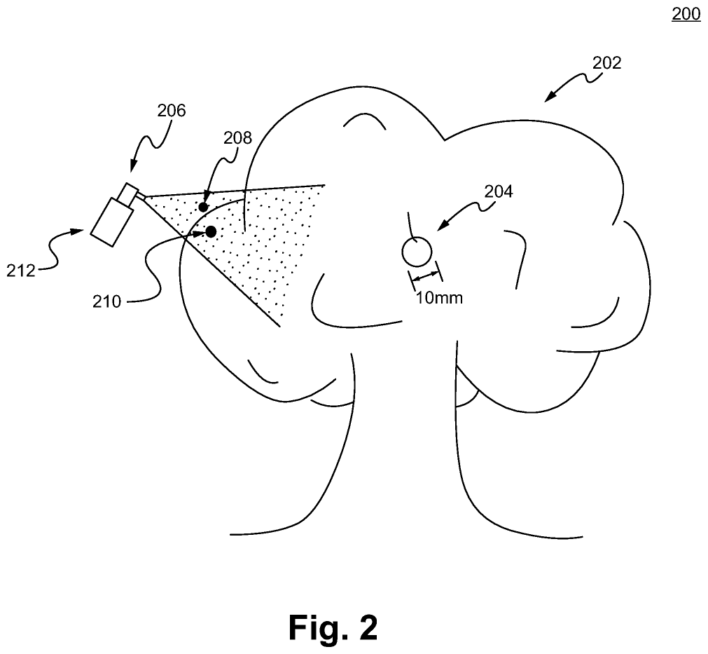

FIG. 2 illustrates a plant regulator composition application method 200 in accordance with some embodiments. A plant regulator composition 212 is prepared, which is able to be in a solution form, a powder form, or any other form for applications. An application device 206 is able to be used to apply the composition 212, which is able be prepared via the method described above (e.g., including Component 1 208 and Component 2 210). For example, a plant regulator solution is applied on to fruits 204 having a size greater than 10 mm on a tree 202.

### EXAMPLES

The disclosure will now be further illustrated with reference to the following examples.

### Example 1

Two Cherry (Bing variety) trials are conducted in Lodi, Calif. to compare growth regulation effects of Gibberellic acid (GA3) and Composition of GA3 and 24-epibrassinolide (EBR). Typically, GA3 alone is commonly used on cherry at straw color for the elongation of storage life, but the application of GA3 often causes uneven ripening.

TABLE 1
Treatment list and results

| Treatment | Treatment | | |
|---|---|---|---|
| Number | Description | Rate | Result |
| 1 | Sprayed GA3 | GA 3@ 4.0 ppm; | Picked 85% of fruits |
| | solution at | 100 gal water per | in four picks due to |
| | straw color | acre | the uneven ripening |
| 2 | Sprayed EBR + | GA3@4.0 ppm & | picked 85% of fruit |
| | GA3 solution at | EBR@ 0.1 ppm; | in grade A (uniform |
| | straw color | 100 gal water per | color and size) with |
| | | acre | only one pick. |

The result shows that EBR@0.1 ppm when in used with GA3 @4.0 ppm (a ratio of 1:40) facilitate the even ripening, which leads to only one pick is required while the commercial standard with GA3 alone needs four picks.

### Example 2

A table grape (Flame variety) trial was set up in Coachella, Calif. Typically, GA3 alone has been used as a growth stimulator on table grape at sizing (berry size 10-14 mm), but it can cause uneven ripening and size of berry.

TABLE 2
Treatment list and results

| Treatment | Treatment | | |
|---|---|---|---|
| Number | Description | Rate | Result |
| 1 | Sprayed GA3 | GA 3@ 2.00 ppm; | Picked 90% of fruits |
| | solution at | 100 gal water per | in four picks due to |
| | fruit size | acre | the uneven ripening |
| | 12 mm | | and observed varied |
| | | | sizes and colors in |
| | | | same cluster of |
| | | | grapes |
| 2 | Sprayed EBR + | GA3@2.00 ppm & | Picked 85% of |
| | GA3 solution | EBR@ 0.05 ppm; | grape (uniform |
| | at fruit size | 100 gal water per | ripening and size) |
| | 12 mm | acre | with two picks |

The result shows that EBR@0.05 ppm when in used with GA3@2.0 ppm (a ratio of 1:40) facilitate the even ripening, which leads to only two picks are required, while the commercial standard with GA3 alone needs four picks.

### Example 3

A table grape (Thomson green seedless variety) trial is carried out in Mecca, Calif. Typically, GA3 alone has been used as growth stimulator on table grape at sizing (berry size 10-14 mm), but it can cause uneven ripening and size of berry.

TABLE 3
Treatment list and results

| Treatment | Treatment | | |
|---|---|---|---|
| Number | Description | Rate | Result |
| 1 | Sprayed GA3 | GA 3@ 4.0 ppm; | Picked 85% of fruits |
| | solution at | 100 gal water per | in 4 picks due to |
| | fruit size | acre | the uneven ripening |
| | 12 mm | | and observed varied |
| | | | berry sizes in the |
| | | | same cluster. |
| 2 | Sprayed EBR + | GA3@4.0 ppm & | picked 85% of fruit |
| | GA3 solution at | EBR@ 0.1 ppm; | in grape (uniform |
| | fruit size | 100 gal water per | color and size) with |
| | 12 mm | acre | only one pick |

The result shows that EBR@0.1 ppm when in used with GA3 @4.0 ppm (the ratio of 1:40) facilitate the even ripening, which leads to only one pick is required, while the commercial standard with GA3 alone needs four picks.

### Example 4

A spring wheat (Scotia variety) trial is carried out in Arnprior, Ontario, Canada. Typically, Ethephon alone has been used to reduce lodging in wheat. However, it can lead to the loss of yield, especially when it is sprayed at late booting stage.

TABLE 4
Treatment list and results

| Treatment | Treatment | | |
|---|---|---|---|
| Number | Description | Rate | Result |
| 1 | Untreated Check | | Yield: 2.00 kg/plot |
| 2 | Sprayed Ethrel | Ethephon@0.18% | Yield: 1.84 kg/plot |
| | (e.g., Ethephon) | (w/w) (1.5 L | |
| | solution at | Ethrel/ha); | |
| | late booting | 200 L water per | |
| | stage | hectare | |
| 3 | Sprayed Ethrel | Ethephon@0.18% | Yield: 2.32 kg/plot |
| | (e.g., Ethephon) + | (w/w) (1.5 L | |
| | EBR solution at | Ethrel/ha) & | |
| | late booting | EBR@0.05 ppm; | |
| | stage | 200 L water per | |
| | | hectare | |

The result shows that EBR@0.05 ppm application can save/reverse the loss of yield caused by the Ethephon@0.18% treatment (the ratio of 1:3,600).

In utilization, the compositions are used to correct excessive unidirectional growth caused by typical plant regulators.

In applications, the compositions are prepared in a predetermined solution and applied to the surface of the plants.

We claim:

1. A plant regulator composition having multiple components comprising:
(a) a first component selected from a group consisting of a compound from Brassinosteroids (BRs) family; and
(b) one or more of a second component selected from a group consisting of plant regulators, wherein the second component is not a member of the Brassinosteroids (BRs) family.

2. The composition of claim 1, wherein a weight ratio of the first component and second component is in a range of 1:40,000 to 40,000:1.

3. The composition of claim 1, wherein a weight ratio of the first component and second component is in the range of 1:1,000 to 100:1.

4. The composition of claim 1, wherein a weight ratio of the first component and second component is in the range of 1:40 to 40:1.

5. The composition of claim 1, wherein a weight ratio of the first component and second component is 1:40.

6. The composition of claim 1, wherein the multiple component plant regulator composition is in a form of a solution, an emulsion, a suspension, a dust, a powder, a paste, a granule, a pressing, or a capsule.

7. The composition of claim 1, wherein the multiple component plant regulator composition contains one or more auxiliaries.

8. A plant treating product comprising:
(a) at least a first compound from a brassinosteroids family; and
(b) at least a second compound of another plant regulator different from the first compound.

9. The plant treating product of claim 8, wherein the first compound comprises 24-epibrassinolide.

10. The plant treating product of claim 8, wherein the second compound comprises gibberellic acid.

11. The plant treating product of claim 8, wherein the first compound comprises a main carbon skeleton having a norbrassinolide-like side chain.

12. The plant treating product of claim 11, wherein the first compound comprises 28-norbrassinolide, 28-norcastasterone, 6-deoxo-28-norcastasterone, 28-nortyphasterol, 6-deoxo-28-nortyphasterol, 28-norteasterone, 6-deoxo-28-norteasterone, 3-dehydro-6-deoxo-28-norteasterone, or 26-Norcastasterone.

13. The plant treating product of claim 8, wherein the first compound comprises a main carbon skeleton having a brassinolide-like side chain.

14. The plant treating product of claim 13, wherein the first compound comprises brassinolide, castasterone, 6-deoxocastasterone, typhasterol, teasterone, 2-epicastasterone, 3-epicastasterone, 2,3-diepicastasterone, 1β-hydroxycastasterone, la-hydroxy-3-epicastasterone, 3-epi-6-deoxocastasterone, teasterone-3-myristate, 3-dehydroteasterone, secasterone, 6-deoxotyphasterol, 3-dehydro-6-deoxoteasterone, 2-deoxybrassinolide, teasterone-3-laurate, 6-deoxoteasterone, 6α-hydroxycastasterone, 3-O-β-D-glucopyranosylteasterone, 3-epibrassinolide, 2,3-diepisecasterone, secasterol, cryptolide, 23-dehydro-2-epicastasterone, 3-epi-2-deoxybrassinolide, or castasterone 23-phosphat.

15. The plant treating product of claim 8, wherein the first compound comprises a main carbon skeleton having a 24-epibrassinolide-like side chain.

16. The plant treating product of claim 15, wherein the first compound comprises 24-epicastasterone, 3,24-diepicastasterone, 24-epibrassinolide, 6-deoxo-24-epicastasterone, or 24-episecasterone.

17. The plant treating product of claim 8, wherein the first compound comprises a main carbon skeleton having a dolicholide-like side chain.

18. The plant treating product of claim 17, wherein the first compound comprises dolicholide, dolichosterone, or 6-deoxodolichosterone.

19. The plant treating product of claim 8, wherein the first compound comprises a main carbon skeleton having a 28-homobrassinolide-like side chain.

20. The plant treating product of claim 19, wherein the first compound comprises 28-homocastasterone, 28-homobrassinolide, 28-homoteasterone, 28-homotyphasterol, or 6-deoxe-28-homotyphasterol.

21. The plant treating product of claim 8, wherein the first compound comprises a main carbon skeleton having a 25-homebrassinolide-like chain.

22. The plant treating product of claim 21, wherein the first compound comprises 25-methylcastasterone.

23. The plant treating product of claim 8, wherein the first compound comprises a main carbon skeleton having a 28-homodolicholide-like side chain.

24. The plant treating product of claim 23, wherein the first compound comprises 28-homodolicholide, 28-homodolichosterone, or 6-deoxo-28-homodolichosterone.

25. The plant treating product of claim 8, wherein the first compound comprises a main carbon skeleton having a 25-homodolicholide-like side chain.

26. The plant treating product of claim 25, wherein the first compound comprises 25-methyldolichosterone, 2-deoxy-25-methyldolichosterone, 3-epi-2-deoxy-25-methyldolichosterone, 2-epi-25-methyldolichosterone, 2,3-diepi-25-methyldolichosterone, 6-deoxo-25-methyldolichosterone, 23-O-β-D-glucopyranosyl-25-methyldolichosterone, or 23-O-β-D-glucopyranosyl-2-epi-25-methyldolichosterone.

27. The plant treating product of claim 8, wherein the first compound comprises cathasterone, 28-epihomobrassinolide, 22,23,24-triepibrassinolide, 14-hydroxylated brassinosteroid, 22,23-epoxybrassinosteroid-2,3-diacetates, or biobras-16.

28. The plant treating product of claim 8, wherein the second compound comprises a plant growth promoter or stimulator.

29. The plant treating product of claim 28, wherein the plant growth promoter or stimulator comprises auxins or auxin-like compounds.

30. The plant treating product of claim 28, wherein the plant growth promoter or stimulator comprises a cytokinin.

31. The plant treating product of claim 28, wherein the plant growth promoter or stimulator comprises a gibberellic acid or a gibberellin.

32. The plant treating product of claim 28, wherein the plant growth promoter or stimulator comprises a triacontanol, diethyl aminoethyl hexanoate citrate (DA6), sodium ortho-nitrophenolate, sodium para-nitrophenolate, or sodium 5-nitroguaiacolate.

33. The plant treating product of claim 8, wherein the second compound comprises a plant growth retardant or inhibitor.

34. The plant treating product of claim 33, wherein the plant growth retardant or inhibitor comprises abscisic acid.

35. The plant treating product of claim 33, wherein the plant growth retardant or inhibitor comprises an anti-auxin.

36. The plant treating product of claim 33, wherein the plant growth retardant or inhibitor comprises an anti-gibberellin.

37. The plant treating product of claim 33, wherein the plant growth retardant or inhibitor comprises butralin, cyclanilide, chlorpropham (CIPC), or choline chloride.

38. The plant treating product of claim 8, wherein the second compound comprises an ethylene releaser.

39. The plant treating product of claim 8, wherein the second compound comprises allantoin, gamma-aminobutyric acid (GABA), complex polymeric polyhydroxy acids (CPPA), L-glutamic acid, harpin proteins, jasmonates, seaweed extracts, chitosan, oligosaccharides, polyamines (PAs), Lysophosphatidylethanolamine (LPE), Laminarin, potassium silicate, 1-octanol, vitamin C (Vc), salicylic acid (SA), or strigolactone.

40. A method of plant treatment comprising:
(a) preparing a plant treating solution containing at least a first compound from a brassinosteroids family and a second compound of another plant regulator; and
(b) applying the plant treating solution to a part of a plant.

41. The method of claim 40, wherein the applying the plant treating solution comprising spraying the plant treating solution after a size of fruits of the plant is no less than 10 mm.

42. The method of claim 40, wherein the first compound comprises 24-epibrassinolide.

43. The method of claim 40, wherein the second compound comprises gibberellic acid.

44. The method of claim 40, wherein the second compound comprises ethephon.
